(19) United States
(12) Patent Application Publication
(10) Pub. No.: US 2016/0168882 A1
(43) Pub. Date: Jun. 16, 2016

(54) DOOR LATCH DEVICE OF VEHICLE

(71) Applicant: KIA MOTORS CORPORATION, Seoul (KR)

(72) Inventor: Jin Sang CHUNG, Suwon-si (KR)

(21) Appl. No.: 14/926,876

(22) Filed: Oct. 29, 2015

(30) Foreign Application Priority Data
Dec. 16, 2014 (KR) 10-2014-0180927

(51) Int. Cl. E05B 77/06; E05B 79/20; E05C 3/16

(52) U.S. Cl. CPC E05B 77/06; E05C 3/16; E05B 79/20

(57) ABSTRACT

A door latch device includes a cable, a lever, biased by a spring, rotatable along a rotation path when pulled by the cable, a back plate, a cable disengagement preventing portion branched from the back plate, and a lever rotation preventing portion extending from an end of the cable disengagement preventing portion. The lever rotation preventing portion is deformable by an external force to the rotation path of the lever so as to prevent unlocking of the door latch.

### CROSS-REFERENCE TO RELATED APPLICATION

This application claims under 35 U.S.C. §119(a) the benefit of Korean Patent Application No. 10-2014-0180927 filed on Dec. 16, 2014 in the Korean Intellectual Property Office, the entire contents of which are incorporated herein by reference.

### TECHNICAL FIELD

The present disclosure relates to a latch device of a vehicle, and more particularly, to a door latch device for preventing unintended opening of the door during a side collision of a vehicle.

### BACKGROUND

Generally, a vehicle door includes an outside handle and an inside handle for opening and closing the door, and a door latch assembly unlocked by the outside handle or the inside handle mounted inside a door panel.

Referring to FIG. 1, a conventional door latch assembly is constituted by parts such as a cable, a back plate 20 and a lever 30. When a cable connected to the outside handle is pulled, a lever 30 rotates in a counterclockwise direction by a cable end portion 10 connected to the lever 30, and thus, locking of the door latch is released.

However, in the case of the conventional door latch assembly, when the cable is pulled simultaneously with the cable disengagement due to the door latch breakage during side collision of the vehicle, the lever is rotated in the counterclockwise direction, the locking of the door latch is released regardless of the intention of user, the door opening phenomenon occurs, and thus, the regulatory dissatisfaction cases frequently occur during the collision test.

In order to prevent the unintended door opening phenomenon during the side collision of the vehicle, although a balance weight structure having inertial moment has been applied to a conventional door outside handle, even in this case, as an amount of intrusion of a barrier pushed from the door side increases, the door latch is damaged, and when the cable pulling phenomenon occurs, it is not possible to prevent the door opening phenomenon.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

An object thereof is to provide a door latch device of a vehicle that can prevent an occurrence of door opening phenomenon due to unlocking of the door latch, regardless of the user's intention during the side collision.

In one aspect, the present invention provides a door latch device in which, when a cable connected to an outside handle of the door, a cable end portion integrally formed at the end portion of the cable is pulled to one side, and when a lever rotatably mounted to one side of a back plate and connected to the cable end portion rotates in a door opening direction, locking of the door latch is released, wherein a lever rotation preventing portion is formed integrally with one side of the back plate, and the lever rotation preventing portion is deformed so as to block a rotation path of the lever by the barrier pushed from the door side during occurrence of the side collision, thereby blocking the rotation of the lever to be able to prevent the unlocking of the door latch.

According to the embodiment of the present invention, a cable disengagement preventing portion integrally connected between the back plate and the lever rotation preventing portion is formed, the cable disengagement preventing portion is formed so as to surround a neck of the cable end portion. When the cable is pulled in the door opening direction during occurrence of the side collision, it is possible to prevent disengagement of the cable, while the cable disengagement preventing portion and the back plate are plastically deformed.

In another aspect, the present invention provides a door latch device including a cable, a lever, biased by a spring, rotatable along a rotation path when pulled by the cable, a back plate, a cable disengagement preventing portion branched from the back plate, and a lever rotation preventing portion extending from an end of the cable disengagement preventing portion. The lever rotation preventing portion is deformable to the rotation path of the lever.

The cable end portion is secured by the cable disengagement preventing portion by inserting a neck of the cable end portion into an opening formed in the cable disengagement preventing portion.

According to the door latch device of vehicle according to the present invention, it is possible to prevent an unintentional door opening phenomenon in which the cable is pulled simultaneously with the cable disengagement due to the door latch failure during the side collision, the lever is rotated, and the lock of the door latch is released regardless of the users intention, and it is possible to prevent the problem of regulatory dissatisfaction due to the door opening phenomenon.

Other aspects and preferred embodiments of the invention are discussed infra.

It is understood that the term “vehicle” or “vehicular” or other similar term as used herein is inclusive of motor vehicles in general such as passenger automobiles including sports utility vehicles SUV, buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles e.g. fuels derived from resources other than petroleum. As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram schematically illustrating an operation structure of a conventional door latch assembly;

FIG. 2 is a diagram schematically illustrating a door latch device of a vehicle according to an embodiment of the present invention;

FIG. 3 is a diagram schematically illustrating an operation structure during side collision of a door latch device according to an embodiment of the present invention; and

FIG. 4 is a diagram showing a lever rotation preventing portion and a cable disengagement preventing portion formed integrally with a back plate of the door latch device according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the preferred embodiment of the present invention will be described with reference to the accompanying drawings so as to be easily implemented by a person having an ordinary knowledge in the art to which this invention pertains.

In the present invention, in order to prevent the cable disengagement due to damage of the door latch and the door-opening phenomenon due to pulling during occurrence of side collision in which the barrier is pushed from the door side, by forming a shape for the cable disengagement prevention and a structure for the lever rotation prevention in a back plate of the door latch, it is possible to prevent an occurrence of the unintended door opening phenomenon due to unlocking of the door latch caused by the shock of the barrier coming from the door side.

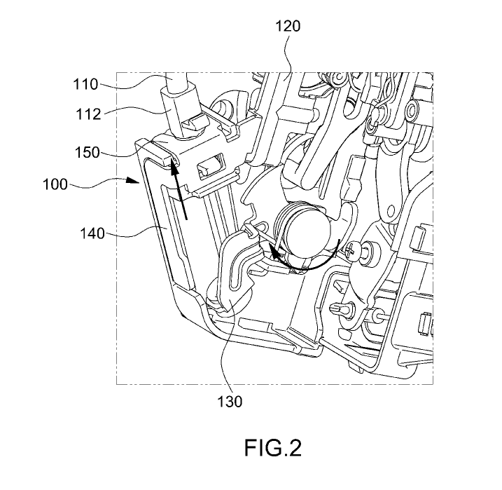

Referring to FIG. 2, a door latch 100 is configured to include a cable 110 connected to the door outside handle (not shown), a cable end portion 112 formed so as to be movable integrally with an end portion of the cable 110, and a lever 130, rotatably mounted on one side of the back plate 120 and connected to the lower portion of the cable end portion 112.

In the door latch 100, before the side collision of the vehicle occurs, by operating the door outside handle, the cable 110 connected to the outside handle is pulled in the door opening direction (upward), and thus, a cable end portion 112 formed at an end portion of the cable 110 is pulled to one side. Thus, a lever 130 connected to the lower side of the cable end portion 112 rotates in the door opening direction, and then, the locking of the door latch 100 is released, thereby allowing opening of the door.

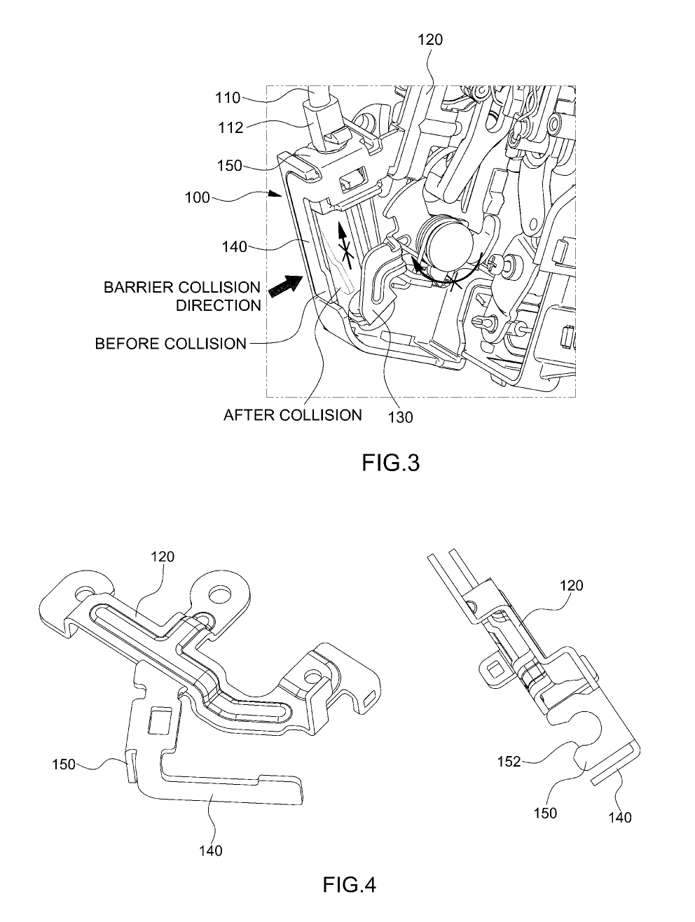

Referring to FIGS. 2 and 3, a lever rotation preventing portion 140 and a cable disengagement preventing portion 150 are formed integrally in the back plate 120.

Since the lever rotation preventing portion 140 is formed integrally on one side of the back plate 120, the lever rotation preventing portion 140 is configured at a position facing a collision direction of the barrier pushed from the door side during an occurrence of the side collision of the vehicle. Thus, since the lever rotation preventing portion 140 is deformed by the barrier pushed from the door side to block the rotation path of the lever 130, even if the unintended pulling of the cable 110 occurs, the lever rotation preventing portion 140 serves to prevent lever 130 from unintentionally rotating in the door opening direction.

Referring to FIG. 3, the lever rotation preventing portion 140 is deformed such as being bent or curved to the cable end portion 112 side when deformed by the barrier, thereby blocking the rotation of the lever 130 connected to the cable end portion 112. As a result, it is possible to prevent the unlocking of the door latch 100 and to prevent the unintended door opening.

The cable disengagement prevention portion 150 is formed integrally with one side of the back plate 120 and is configured to have a form that is integrally connected between the back plate 120 and the lever rotation preventing portion 140.

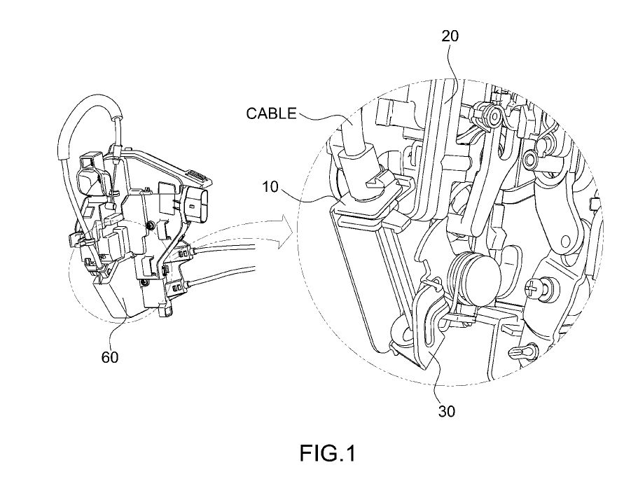

When the side collision of the vehicle occurs, if the disengagement of the cable end portion 10 (see FIG. 1) occurs due to the breakage of a latch case (see 60 of FIG. 1) of the door latch, the cable is disengaged while being pulled in the door opening direction.

However, according to an embodiment of the present invention, the cable disengagement preventing portion 150 is formed so as to surround the neck of the cable end portion 112. Thus, if the cable 110 is pulled in the door opening direction when the side collision occurs, since the cable disengagement preventing portion 150 is plastically deformed together with the lever rotation preventing portion 140 and the back plate 120, it is possible to prevent the pulling/disengagement of the cable.

That is, since the cable disengagement preventing portion 150 surrounds the neck of the cable end portion 112, even if the latch case is damaged during the side collision, it is possible to improve the phenomenon in which the cable 110 is pulled in the door opening direction and is disengaged.

Further, as shown in FIG. 4, the cable disengagement preventing part 150 has an opening 152 on its one side so as to ensure the assembling characteristics when assembled to the neck of the cable end portion 112.

While the detail embodiments of the present invention have been described, the scope of the present invention is not limited to the above-described embodiments, and various modifications and improvements of those skilled in the art that utilize the basic concept of the present invention that are defined in the following claims are also included in the scope of the invention.

What is claimed is:

1. A door latch device in which, when a cable connected to an outside handle of a door is pulled in a door opening direction, a cable end portion integrally formed at an end portion of the cable is pulled to one side, and when a lever rotatably mounted to one side of a back plate and connected to the cable end portion rotates in a door opening direction, locking of the door latch is released,
wherein a lever rotation preventing portion is formed integrally with one side of the back plate, and the lever rotation preventing portion is deformed so as to block a rotation path of the lever by the barrier pushed from the door side during occurrence of the side collision, thereby blocking the rotation of the lever to be able to prevent the unlocking of the door latch.

2. The door latch device of claim 1, wherein a cable disengagement preventing portion integrally connected between the back plate and the lever rotation preventing portion is formed, the cable disengagement preventing portion is formed so as to surround a neck of the cable end portion, and when the cable is pulled in the door opening direction during occurrence of the side collision, disengagement of the cable can be prevented, while the cable disengagement preventing portion and the back plate are plastically deformed.

3. The door latch device of claim 2, wherein the cable disengagement prevention portion has an opening on its one side to secure assembling characteristics when assembled to the neck of the cable end portion.
